(19) United States
(12) Patent Application Publication
(10) Pub. No.: US 2019/0183069 A1
(43) Pub. Date: Jun. 20, 2019

(54) Plant Growing Apparatus

(71) Applicants: Michael Sawyer, Westmoreland, TN (US); Randall Putala, Nashville, TN (US)

(72) Inventors: Michael Sawyer, Westmoreland, TN (US); Randall Putala, Nashville, TN (US)

(21) Appl. No.: 16/013,008

(22) Filed: Jun. 20, 2018

Related U.S. Application Data
(60) Provisional application No. 62/604,052, filed on Jun. 22, 2017.

(51) Int. Cl. A01G 9/24; A01G 9/02

(52) U.S. Cl. CPC A01G 9/243; A01G 9/20; A01G 9/023

(57) ABSTRACT

A plant growing apparatus is described. In some examples, the plant growing apparatus includes a carousel that is powered such that controlled movement of tubs/containers/vessels with plants or plant matter on the carousel about an axis allows for controlled and measured exposure of the plants/plant matter to predetermined frequencies of light from a light source. The light sources are positioned such that, as the plants/plant matter pass by the light sources in a controlled and timed rotation, a predictable amount of light in predetermined frequencies that is necessary to promote healthy plant growth is provided to the plant/plant matter. The described plant growing apparatus including the carousel provides a uniform distribution of light vis-à-vis traditional plant growing methods and therefore achieves higher yields from the plant/plant matter.

### RELATED APPLICATIONS

This application claims the benefit of U.S. Provisional Application No. 62/604,052, entitled “Lighted Plant Grow Carousel” and filed on Jun. 22, 2017, which is incorporated herein by reference in its entirety.

### FIELD

Some implementations relate generally to an apparatus for growing plants in commercial and residential hydroponic growing enclosures while ensuring that the plants receive the appropriate amount of light from each of the necessary frequencies, i.e., a plant growing apparatus. The implementations thus generally relate to plant growing apparatus.

### BACKGROUND

There exist in the art a variety of structures and enclosures designed to grow vegetables and plants in a variety of climates and conditions. Such structures and/or enclosures are, for example, useful where either the local weather conditions are not conducive to successful production of plant matter via the traditional growing process or there is insufficient land, water or other critical resources required for traditional farming or growing of plants and vegetables.

Many of the existing structures/devices for growing plants/plant matter under controlled conditions are designed to accommodate a specific yield or quantity of plants/plant matter using stationary tubs/containers/vessels that hold a given number or quantity of plants/plant matter. In some implementations, sea containers or cargo containers or shipping containers that are used to transport commercial goods on ships are deployed to house the plant growing structures/devices. The different varieties or quantities of tubs/containers/vessels used specifically for housing the plants/plant matter during the growth cycle are placed in such sea/cargo/shipping containers.

The traditional structures used for growing plants/plant matter as described above employ stationary positioning of racking or holding the tubs/containers/vessels due to which the quantity of tubs/containers/vessels that can be included in such structures is limited. This limitation arises from the typical method of providing the appropriate amount of light with necessary frequencies or spectrums to the plants/plant matter from a fixed position and within a fixed distance above the plants/plant matter. As the effectiveness of the typical “grow lights” used to provide required light frequencies/spectrums to the plants/plant matter depends on their positioning and proximity to the plants/plant matter, limited space in the sea/cargo/shipping containers leads to constraints.

In typical enclosures used for growing plants/plant matter, the stationary/fixed position of the plant/plant matter and the stationary/fixed positioning of the growth lighting results in gaps in the uniform distribution of light frequencies. Non-uniform distribution of light frequencies leads to unpredictable/irregular growth patterns, thereby affecting yield from the plants/plant matter.

For reasons stated above and others that will become apparent to those skilled in the art, there is a need for a more versatile plant growing apparatus that allows for placement of more tubs/containers/vessels in a sea/cargo/shipping container or similar storage environment and provides a more effective light source, e.g., a non-stationary light source, for delivering the necessary light frequencies and spectrums to increase the total plant/plant matter yield.

It may be thus desirable to provide an apparatus for growing plants or plant matter using accommodations such as tubs, containers or vessels in a manner that makes adequate light of the necessary frequencies available to such plants. Some implementations were conceived in light of the above-mentioned needs, limitations, or problems, among other things, related to the growing of plant/plant matter within tubs/containers/vessels placed within sea/cargo/shipping containers.

### SUMMARY

Some implementations include a plant growing apparatus comprising a frame portion, a chain assembly, a top axle assembly, a bottom axle assembly, one or more swing assemblies, a drive mechanism and one or more light sources. Each swing assembly supports a container, which is attached to the chain assembly through a yoke assembly. The drive mechanism facilitates coordinated motion of the swing assemblies and the containers. Also, each light source is positioned such that each container receives uniform distribution of light from a light source.

The frame portion can be mounted in a vertical position or a horizontal position. In some implementations, the chain assembly comprises chain made of a non-mechanical flexible material with adequate strength to support the load of swing assemblies and containers.

The drive mechanism can be controlled using at least one of electrical, mechanical and electro-mechanical means. Also, the drive mechanism can be operated using at least one of manual and automated means. The containers can be made of plastic, metal, clay, wood, glass, stone, composite, synthetic, natural and man-made material. Also, the containers are configured to carry and bear the weight of plants, water, plant matter, soil, growth media and plant nutrients.

The one or more swing assemblies are caused to rotate about an upper axle and a lower axle at a predetermined rate of motion. Also, the one or more swing assemblies can be caused to move along one of a vertical elliptical path and a horizontal elliptical path. Each of the one or more swing assemblies is mechanically coupled to the chain assembly using the yoke assembly.

The one or more light sources is located at a predetermined distance and direction from a path of motion of the containers. Also, the light sources can be mounted in a vertical position or a horizontal position. The light sources can be stationary or move about at least one of a lateral and rotational axis. In some implementations, the one or more light sources is configured to transmit light at one or more frequencies for one or more predetermined time periods. In some other implementations, the one or more light sources is set up to move along a predetermined path during a predetermined time frame.

A method for growing plants in artificially lighted environments, the method comprising positioning one or more artificial light sources on a frame and moving containers with plants around the frame. In some implementations, each artificial light source is positioned such that each of the containers receives uniform distribution of light from the artificial light sources. In some other implementations, the artificial light sources can be configured to transmit light at one or more frequencies for one or more predetermined time periods. In yet other implementations, the one or more artificial light sources is located at a predetermined distance and direction from a path of motion of the containers.

### BRIEF DESCRIPTION OF THE DRAWINGS

FIG. 1 is a diagram showing a front perspective view of an example plant growing apparatus in accordance with some implementations.

FIG. 2 is a diagram showing top, front and side elevation views of an example swing assembly in accordance with some implementations.

FIG. 3 is a diagram showing front and side elevation views of example chain and yoke assemblies in accordance with some implementations.

### DETAILED DESCRIPTION

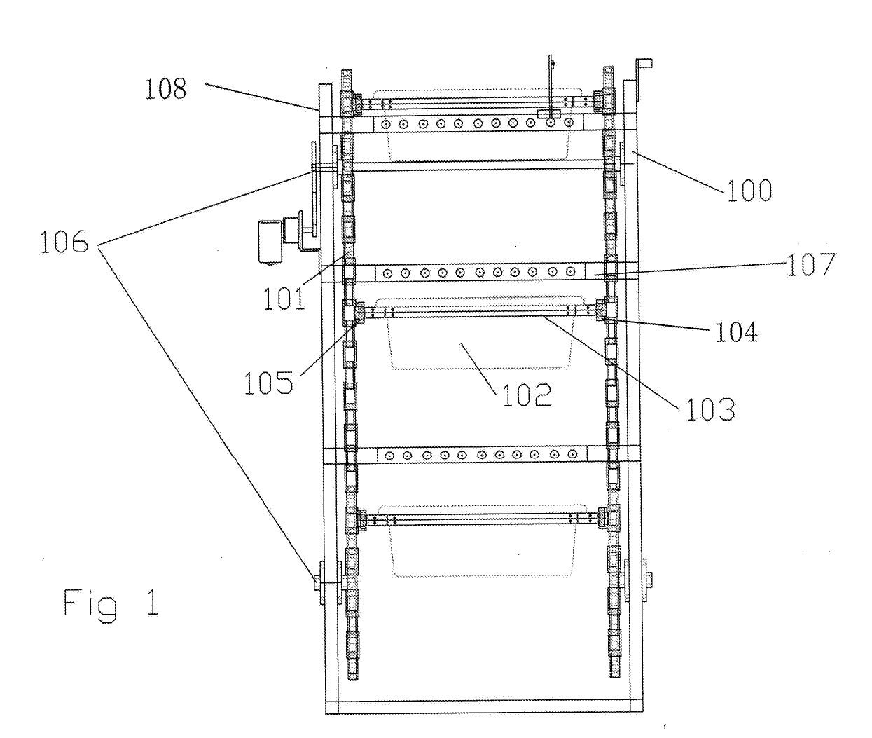

FIGS. 1-3 show diagrams of an example plant growing apparatus (e.g., 100). As shown in FIG. 1, an example rack assembly 100 includes a frame 108, chain assembly 101, containers 102, swing assemblies 103, yokes 104, yoke assemblies 105, top and bottom axle assemblies 106, and light sources 107. The frame can be rigid and support the weight of plants/plant matter, growth media, soil and water required to grow the plants/plant matter. The drive mechanism facilitates coordinated motion of containers 102 supported by the swing assemblies 103 and held in place by the yoke assemblies 105, which are in turn mechanically coupled to the chain assembly 101.

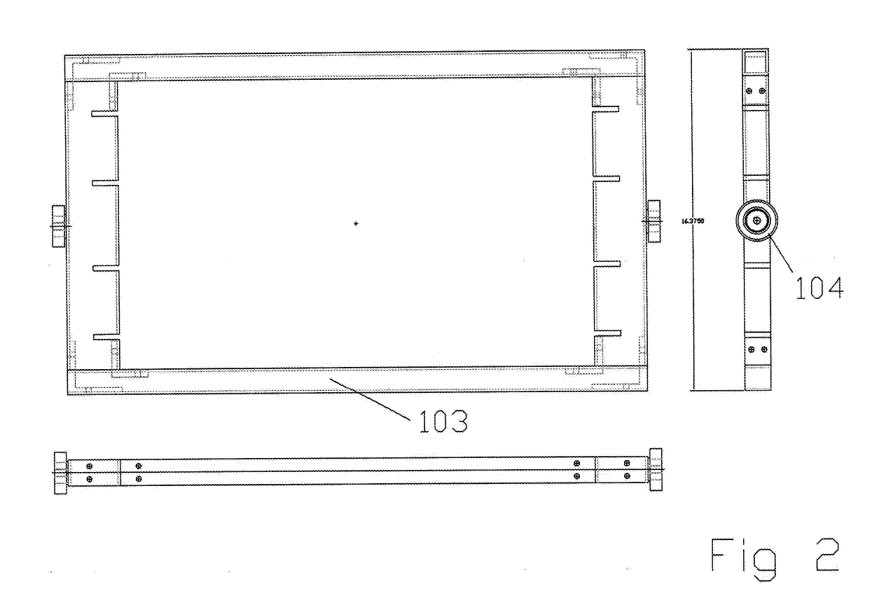

FIG. 2 shows top, front and side views of an example swing assembly 103 and yoke 104 with illustrative container geometry and bearings. The swing assembly 103 and yoke 104 in FIG. 2 can be configured to firmly hold in place a variety of plastic, metallic, glass, clay, composite, and synthetic containers along with the necessary soil, growth media, water and plant nutrients.

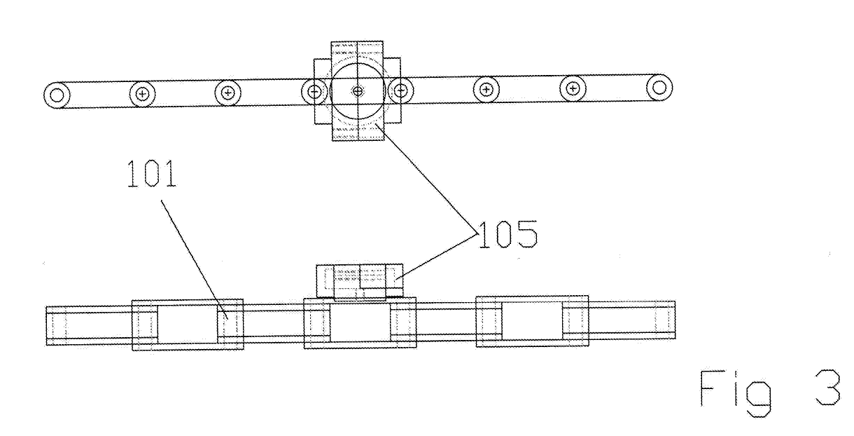

FIG. 3 shows front and side views of an example chain assembly 101 and yoke assembly 105. The chain assembly 101 in FIG. 3 is controlled either electrically or mechanically to cause the swing assemblies 103 to rotate about an upper axle and a lower axle, which are held in place using a bearing and sprocket assembly 106, at a predefined rate of motion in a vertical elliptical path. The resulting motion of the containers 102 with the plants/plant matter around the light sources 107 emulates the movement of earth around the sun and enables the growth of plants.

In some implementations, a rack assembly, e.g., a racking system, can be oriented in a vertical format. A series of containers, e.g., pots, tubs or vessels, are suspended between heavy duty chains such that the containers are held in place but able to swing freely between the chain lengths. The containers are placed in a swing assembly configured to encompass the container on its perimeter by placing the container inside the swing from the top side and allowing gravity to hold in place the container based on the container rim's geometry. On either side of the swing, round protrusions are provided and on these protrusions, ball bearings or sleeve bearings are placed. When these bearings are fixed in place by friction fit between the round stationary protrusion and the bearing, the swing assembly can be added to the chain lengths, on which the swing assemblies are placed at predetermined intervals. Yokes or bearing blocks, which are part of yoke assemblies, hold the swing assembly firmly while allowing free movement of the swing.

The frame or structure on which the chain lengths are mounted holds an upper axle and a lower axle. These axles are configured with sprockets on which the chain lengths rest. The upper and lower axle assemblies support the weight as well as the movement of the vertical chain and the swing assemblies. Since the rack assembly, i.e., the carousel, is mounted vertically, a larger number of containers can be arranged, thereby increasing the yield from the plants/plant matter.

The rack/carousel assembly is rotated around the stationary frame and driven electrically by means of electric motors (e.g., AC or DC) and may be controlled in its speed or movement. It will be appreciated that the sources of energy described herein for driving the rack assembly are for illustration purposes only and are not intended to be limiting. Other mechanisms, such as mechanical, among others, could be used depending on a contemplated implementation.

The plant/plant matter is placed in a container and the containers are spaced appropriately to facilitate any given type of plant/plant matter, whose grown height is known, to move or pass freely by and between the container above and container below the plant without damaging the plants/plant matter in the said containers during the growth cycle of the plants/plant matter. Light sources are placed on the frame at predetermined intervals and the position of light sources can be adjusted. Containers pass by the stationary light sources at predefined speed and proximity to provide the plants/plant matter adequate quantity of light of appropriate frequencies. The position of the light sources and the movement of the containers are configured to emulate the movement of earth moving around the sun, which provides plants light required for their growth.

The artificial light sources are configured to transmit light frequencies that are known to be beneficial to different types of plants. This arrangement allows various types of plants/plant materials to be grown effectively in the same space by simply changing the frequency of light that a plant requires. Thus, all necessary light frequencies are provided by these light sources. Exposure to light frequencies required by plants/plant matter from the artificial light sources promotes photosynthesis. It will be appreciated that the light sources described herein are for illustration purposes only and are not intended to be limiting. Other light sources such as LED and halogen lights, among others, can be used depending on a contemplated implementation.

In some implementations, the light sources can be mounted horizontally while in other implementations, the light sources can be mounted vertically. In some other implementations, a non-stationary light source can be arranged to move laterally or rotate about an axis to uniformly and effectively distribute the necessary light frequencies and lumens to facilitate growth of the plants/plant matter in the containers. Other implementations can include movable light sources that can be set or programmed to move according to predefined time periods corresponding to the movement of sun in nature over a certain time frame and proximity to plants/plant matter.

Some implementations include horizontal rack or carousel assemblies instead of the vertical assemblies disclosed. In some other implementations, the vertical rack or carousel assemblies can be structured such that the entire space within standard sea/cargo/shipping containers is utilized completely to accommodate rack or carousel assemblies without any wastage of space. Rack assemblies can thus be designed to optimally use container space. Sea/cargo/shipping containers typically span 20 to 40 feet in length. For example, rack assemblies can be designed to each span 2 feet so that 10 such assemblies optimally fill a sea/cargo/shipping container of 20 feet or 20 such assemblies fit into a container of 40 feet.

In some implementations, each rack or carousel assembly operates independently of the other, while in other implementations, multiple rack or carousel assemblies can be operated as a single unit, a group of units, multiple groups of units, or in parallel.

It will be appreciated that the nature of the drive mechanism described herein is for illustration purposes only and is not intended to be limiting. The drive mechanism can be operated mechanically, electrically or electromechanically. In some implementations, the mechanism is operable manually while in other implementations, it can be automated.

It will be appreciated that the mechanical nature of the chain assembly described herein is for illustration purposes only and is not intended to be limiting. In some implementations, a flexible material that is not mechanical in nature can be used in the chain assembly. Such material will have adequate strength to support the load and is dimensionally stable in motion.

It is therefore apparent that there is provided, in accordance with the various example implementations disclosed herein, a plant growing apparatus.

While the disclosed subject matter has been described in conjunction with a number of implementations, it is evident that many alternatives, modifications and variations would be or are apparent to those of ordinary skill in the applicable arts. Also, other implementations with logical, mechanical and electrical changes may be utilized. Accordingly, Applicant intends to embrace all such alternatives, modifications, equivalents, changes and variations to disclosed implementations that are within the spirit and scope of the disclosed subject matter herein.

What is claimed is:

1. A plant growing apparatus comprising:
a frame portion;
a chain assembly;
a top axle assembly;
a bottom axle assembly;
one or more swing assemblies, wherein each of the one or more swing assemblies supports a container and is attached to the chain assembly through a yoke assembly;
a drive mechanism, wherein the drive mechanism facilitates coordinated motion of the swing assemblies and the containers; and
one or more light sources, wherein each light source is positioned such that each of the containers receives uniform distribution of light from the one or more light sources.

2. The plant growing apparatus of claim 1, wherein the drive mechanism is controlled using at least one of an electrical, a mechanical, and an electro-mechanical means.

3. The plant growing apparatus of claim 1, wherein the drive mechanism is operated using at least one of a manual and an automated means.

4. The plant growing apparatus of claim 1, wherein the one or more swing assemblies are caused to rotate about an upper axle and a lower axle at a predetermined rate of motion.

5. The plant growing apparatus of claim 1, wherein the one or more swing assemblies are caused to move along one of a vertical elliptical path and a horizontal elliptical path.

6. The plant growing apparatus of claim 1, wherein the container is made of at least one of plastic, metal, clay, wood, glass, stone, composite, synthetic, natural, and man-made material.

7. The plant growing apparatus of claim 1, wherein the container is configured to carry at least one or more of plants, water, plant matter, soil, growth medium, and plant nutrients.

8. The plant growing apparatus of claim 1, wherein each of the swing assemblies is mechanically coupled to the chain assembly using the yoke assembly.

9. The plant growing apparatus of claim 1, wherein the one or more light sources is configured to transmit light at one or more frequencies for one or more predetermined time periods.

10. The plant growing apparatus of claim 1, wherein the one or more light sources is located at a predetermined distance and direction from a path of motion of the containers.

11. The plant growing apparatus of claim 1, wherein the container is configured to bear weight of plants, soil, plant matter, water, growth medium, and plant nutrients.

12. The plant growing apparatus of claim 1, wherein the one or more light sources is stationary.

13. The plant growing apparatus of claim 1, wherein the one or more light sources moves about at least one of a lateral axis and a rotational axis.

14. The plant growing apparatus of claim 1, wherein the one or more light sources is set up to move along a predetermined path during a predetermined time frame.

15. The plant growing apparatus of claim 1, wherein the frame portion is mounted in one of a vertical position and a horizontal position.

16. The plant growing apparatus of claim 1, wherein the one or more light sources is mounted in one of a vertical position and a horizontal position.

17. The plant growing apparatus of claim 1, wherein the chain assembly comprises a chain made of a non-mechanical flexible material with adequate strength to support a load.

18. A method for growing plants in artificially lighted environments, the method comprising:
positioning one or more artificial light sources on a frame; and
moving containers with plants around the frame.

19. The method of claim 18, wherein each of the artificial light sources is positioned such that each of the containers receives uniform distribution of light from the one or more artificial light sources.

20. The method of claim 18, wherein the one or more artificial light sources is configured to transmit artificial light at one or more frequencies for one or more predetermined time periods.

21. The method of claim 18, wherein the one or more artificial light sources is located at a predetermined distance and direction from a path of motion of the containers.
